(19) United States
(12) Patent Application Publication
(10) Pub. No.: US 2023/0319879 A1
(43) Pub. Date: Oct. 5, 2023

(54) WIRELESS COMMUNICATION SYSTEM

(71) Applicant: DENSO CORPORATION, Kariya-city (JP)

(72) Inventors: SHO MATSUMOTO, Kariya-city (JP); YOUICHI HAYASE, Kariya-city (JP); TOMOHISA KISHIGAMI, Kariya-city (JP); YUTO HONDA, Kariya-city (JP); RYU ATSUTA, Kariya-city (JP)

(21) Appl. No.: 18/178,258

(22) Filed: Mar. 3, 2023

(30) Foreign Application Priority Data
Apr. 5, 2022 (JP) 2022-063115

(51) Int. Cl. H04W 74/08

(52) U.S. Cl. CPC H04W 74/0808

(57) ABSTRACT

A wireless communication system is mounted on a mobile body, and includes: a master device; and a slave device that performs a wireless communication with the master device while switching a frequency channel. The master device determines whether the frequency channel is available. The master device reflects a result of frequency channel availability determination in a use of the frequency channel.

### CROSS REFERENCE TO RELATED APPLICATION

The present application claims the benefit of priority from Japanese Patent Application No. 2022-063115 filed on Apr. 5, 2022. The entire disclosure of the above application is incorporated herein by reference.

### TECHNICAL FIELD

The present disclosure relates to a wireless communication system.

### BACKGROUND

In a comparative example, a wireless communication system is mounted on a mobile body. The wireless communication system includes a master device and a slave device.

### SUMMARY

A wireless communication system is mounted on a mobile body, and includes: a master device; and a slave device that performs a wireless communication with the master device while switching a frequency channel. The master device determines whether the frequency channel is available. The master device reflects a result of frequency channel availability determination in a use of the frequency channel.

### BRIEF DESCRIPTION OF DRAWINGS

FIG. 1 is a block diagram showing a wireless communication system according to a first embodiment.

FIG. 2 is a diagram showing one example of a communication sequence between a master device and a slave device.

FIG. 3 is a diagram showing an electric field strength distribution of a communication environment.

FIG. 4 is a diagram showing one example of available frequency channels.

FIG. 5 is a block diagram showing a configuration of a control circuit of the master device.

FIG. 6 is a flowchart showing one example of an availability propriety determination process.

FIG. 7 is a diagram showing a hopping pattern of frequency channels.

FIG. 8 is a diagram showing a state switching timing and a change in quality index.

FIG. 9 is a flowchart showing one example of an availability property determination process executed by the master device in a wireless communication system according to a second embodiment.

FIG. 10 is a flowchart showing one example of an availability property determination process executed by the master device in a wireless communication system according to a third embodiment.

FIG. 11 is a flowchart showing one example of an availability property determination process executed by the master device in a wireless communication system according to a fourth embodiment.

FIG. 12 is a flowchart showing one example of an availability property determination process executed by the master device in a wireless communication system according to a fifth embodiment.

FIG. 13 is a diagram showing a state switching timing and a change in quality index in a wireless communication system according to a sixth embodiment.

### DETAILED DESCRIPTION

An electric field of a communication environment changes depending on at least one of a state of the mobile body or a state of a surrounding environment of the mobile body. However, in a comparative example, a system sets a threshold for each frequency channel in a wireless communication between the master device and the slave device, and determines that a communication quality deteriorated when a reception signal strength or the like exceeds a threshold. Then, the system changes the frequency channel to another frequency channel whose communication quality does not deteriorate. Accordingly, even when the state changes, in other words, the electric distribution changes and the communication environment deteriorates, the frequency channel cannot be switched until the reception signal strength or the like exceeds the threshold. Communication errors may occur continuously. In the above-mentioned viewpoints or in other viewpoints not mentioned, further improvements are required in the wireless communication system.

One example of the present disclosure provides a wireless communication system capable of performing a wireless communication with a high reliability.

According to one example, a wireless communication system is mounted on a mobile body. The system includes: a master device; and a slave device that performs a wireless communication with the master device while switching a frequency channel. In response to switching of at least one of a state of the mobile body or a surrounding environment state of the mobile body from a first state to a second state, the master device determines whether the frequency channel is available based on a change amount of an index indicating a communication quality. The communication quality is a communication quality in a period between a switching timing from the first state to the second state and a predetermined timing before the switching timing. The master device reflects the determination result in the use of the frequency channel.

The value of the communication quality index is affected by the electric field distribution in the usage environment. The index changes greatly at the timing when the electric field distribution changes. In the wireless communication system, the master device determines whether each frequency channel is available based on the amount of change in the index in a period immediately before the switching to the second state. Then, the determination result is reflected in the use of the frequency channel. Thereby, it is possible to provide the wireless communication system capable of highly reliable wireless communication.

Hereinafter, multiple embodiments will be described with reference to the drawings. The same reference numerals are assigned to the corresponding elements in each embodiment, and thus, duplicate descriptions may be omitted. In each of the embodiments, when only a part of the configuration is described, the remaining parts of the configuration may adopt corresponding parts of other embodiments. Further, not only the combinations of the configurations explicitly shown in the description of the respective embodiments, but also the configurations of the plurality of embodiments can be partially combined even when they are not explicitly shown as long as there is no difficulty in the combination in particular.

### First Embodiment

A wireless communication system according to a present embodiment is mounted on a mobile body. The mobile body include, for example, a vehicle such as an automobile and a railroad vehicle, a flying object such as an electric vertical take-off and landing aircraft and a drone, a ship, a construction machine, and an agricultural machine.

### <Overview of Wireless Communication System>

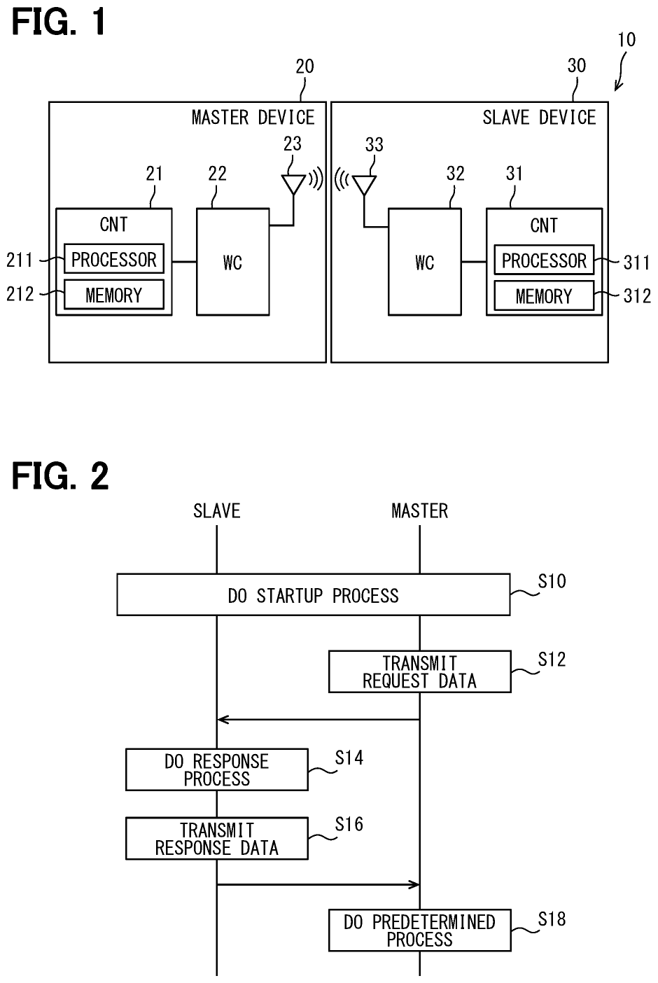

FIG. 1 is a block diagram showing a schematic configuration of a wireless communication system. A wireless communication system 10 is mounted on a vehicle (subject vehicle), for example. The wireless communication system 10 includes at least one master device 20 and at least one slave device 30. The master device 20 may be also referred to as a master node, a master, or the like. The slave device 30 may be also referred to as a slave node, a slave, or the like. The master device 20 and the slave device 30 perform wireless communication while switching a frequency channel to be used. Hereinafter, the master device 20 and the slave device 30 may be also referred to as devices 20 and 30.

In one example, the wireless communication system 10 according to the present embodiment includes one master device 20 and one slave device 30. Alternatively, the wireless communication system 10 may include multiple slave devices 30 that individually wirelessly communicate with one master device 20. The wireless communication system 10 may include multiple master devices 20 for redundancy, for example, and may be configured such that the slave device 30 performs wireless communication with each master device 20. The master device 20 and the slave device 30 may be placed in a common housing, or may not be placed in the common housing.

For the wireless communication between the master device 20 and the slave device 30, a frequency band, for example, the 2.4 GHz, the 5 GHz, or the like for a short-range communication can be used. Such a high-frequency band radio wave has a stronger straightness than a radio wave in the LF band and is easily reflected at a metal body such as a vehicle body. The LF is an abbreviation for Radio Frequency. As standards for short range communication, for example, BLE and ZigBee (registered trademark) can be adopted. The BLE is an abbreviation for Bluetooth Low Energy. The Bluetooth is a registered trademark. In one example, the master device 20 and the slave device 30 according to the present embodiment can perform wireless communication (hereinafter, BLE communication) conforming to a BLE standard. Details of a communication method related to communication connection and encrypted communication are performed by a sequence defined by the BLE standard.

### <Master Device>

The master device 20 includes a control circuit (CNT) 21, a wireless communication circuit (WC) 22, an antenna 23, as shown in FIG. 1. In addition to the elements described above, the master device 20 includes an input-output interface for wired or wireless communication with devices other than the slave device 30, and a bus line.

The control circuit 21 includes, for example, a processor 211 and a memory 212. The memory 212 includes, for example, a RAM and a ROM. The RAM is abbreviation for Random Access Memory. The ROM is abbreviation for Read Only Memory.

The processor 211 of the control circuit 21 executes a predetermined process (control) by executing a program stored in the ROM while using the RAM as a temporary storage area. The processor 211 constructs multiple functional units by executing multiple instructions included in the program. The program storage medium is not limited to the ROM. For example, various storage media such as HDD and SSD can be adopted. The HDD is an abbreviation for Hard-Disk Drive. The SSD is an abbreviation for Solid State Drive.

The processor 211 is, for example, a CPU, MPU, GPU, DFP, or the like. The CPU is an abbreviation for Central Processing Unit. The MPU is an abbreviation for Micro-Processing Unit. The GPU is an abbreviation for Graphics Processing Unit. The DFP is an abbreviation for Data Flow Processor. The control circuit 21 may be implemented by combining multiple types of calculation processing units such as a CPU, an MPU, and a GPU.

The control circuit 21 may be implemented as an SoC. The SoC is an abbreviation for System on Chip. The control circuit 21 may be implemented using an ASIC or FPGA. The ASIC is an abbreviation for Application Specific Integrated Circuit. The FPGA is an abbreviation for Field-Programmable Gate Array.

The control circuit 21 generates a command that requests a process on the slave device 30, and transmits transmission data including the command to the wireless communication circuit 22. The control circuit 21 executes a predetermined process based on information acquired from the slave device 30 by the wireless communication. In one example, the control circuit 21 controls an equipment mounted on a vehicle. One example of the embodiment is a travel actuator. Another example of the equipment is a battery pack including a battery cell. The control circuit 21 may perform control to transmit information acquired from the slave device 30 to another device, for example, a higher-level ECU mounted on the vehicle. The ECU is an abbreviation for Electronic Control Unit.

The wireless communication circuit 22 includes a RF circuit (not shown) for wirelessly transmitting and receiving data. The wireless communication circuit 22 has a transmission function of modulating transmission data and oscillating at the frequency of RF signal. The wireless communication circuit 22 has a reception function of demodulating reception data. The RF is an abbreviation for Radio Frequency.

The wireless communication circuit 22 modulates data transmitted from the control circuit 21, and transmits the data to the slave device 30 via the antenna 23. The wireless communication circuit 22 adds data required for wireless communication, such as communication control information, to transmission data, and transmits the data. The data required for wireless communication includes, for example, an identifier (ID), an error detection code, and the like. The wireless communication circuit 22 may control the data size, communication format, schedule, error detection, and the like of communication between the master device 20 and the slave device 30. Control regarding these communications may be performed by the control circuit 21.

The wireless communication circuit 22 receives data transmitted from the slave device 30 via the antenna 23 and demodulates it. Then, the wireless communication circuit 22 transmits the demodulated data to the control circuit 21. The antenna 23 converts an electric signal into radio waves and emits the radio waves into a space. The antenna 23 receives a radio wave propagating in space and converts it into an electric signal.

### <Slave Device>

The slave device 30 includes a control circuit (CNT) 31, a wireless communication circuit (WC) 32, an antenna 33, as shown in FIG. 1. In addition to the elements described above, the slave device 30 includes an input-output interface for wired or wireless communication with devices other than the master device 20, and a bus line. The control circuit 31 has the similar configuration to the control circuit 21 of the master device 20. The control circuit 31 includes a processor 311 and a memory 312, for example. The memory 312 includes, for example, a RAM and a ROM.

Based on the request command acquired via the wireless communication circuit 32, the control circuit 31 executes a predetermined process (response process) necessary for responding. The control circuit 31 transmits data including the processing result to the wireless communication circuit 32 as a response to the request. The control circuit 31 may execute a process other than response process to the request command, for example, may execute control of devices mounted on the vehicle.

The wireless communication circuit 32 includes a RF circuit (not shown) for wirelessly transmitting and receiving data. The wireless communication circuit 32 has a transmission function and a reception function, similarly to the wireless communication circuit 22. The wireless communication circuit 32 receives data transmitted from the master device 20 via the antenna 33 and demodulates it. Then, the wireless communication circuit 32 transmits the demodulated data to the control circuit 31. The wireless communication circuit 32 modulates data transmitted from the control circuit 31, and transmits the data to the master device 20 via the antenna 33. The wireless communication circuit 32 adds data required for wireless communication, such as communication control information, to transmission data, and transmits the data.

The wireless communication circuit 32 may control the data size, communication format, schedule, error detection, and the like of communication between the master device 20 and the slave device 30. Control regarding these communications may be performed by the control circuit 31. The antenna 33 converts an electric signal into radio waves and emits the radio waves into a space. The antenna 33 receives a radio wave propagating in space and converts it into an electric signal.

### <Wireless Communication>

FIG. 2 is a diagram showing one example of a communication sequence between the master device 20 and the slave device 30. In FIG. 2, the master device 20 is indicated as MASTER, and the slave device 30 is indicated as SLAVE.

As shown in FIG. 2, the master device 20 and the slave device 30 first execute a startup process such as connection establishment (S10). The time of startup is, for example, a time when an operation power is supplied. In a configuration in which the power is constantly supplied, the master device 20 and the slave device 30 are started up after a manufacturing process of the vehicle 10 or the replacement of parts at a repair shop. The time of startup may be a time at which a startup signal such as an IG signal is supplied. For example, when the IG signal is switched from off to on by user operation, the master device 20 and the slave device 30 are started up.

At the time of startup, the startup process is executed between the master device 20 and all the slave devices 30 to which the wireless communication with the master device 20 is connected. The startup process includes, for example, a connection establishment process for establishing wireless communication connection and a pairing process for exchanging unique information for encrypted communication. In the connection establishment process, the slave device 30 performs an advertising operation, and the master device 20 performs a scanning operation. The startup process includes a process of sharing initial information about frequency channel hopping. The initial information includes, for example, a hopping pattern or a function for hopping.

After the process in S10 is completed, the master device 20 and the slave device 30 periodically perform data communication. As shown in FIG. 2, the master device 20 transmits the transmission data including the request command, that is, request data, to the slave device 30 (S12).

Upon receiving the request data, the slave device 30 executes a predetermined process necessary for responding, that is, a response process (514). Next, the slave device 30 transmits data including the processing result to the master device 20 as response data (S16).

Upon receiving the response data, the master device 20 executes a predetermined process based on the information included in the response data (518). The wireless communication system 10 periodically executes the processes in S12 to S18.

The master device 20 switches the frequency channel to be used for each data transmission-reception cycle to transmit the request data and receive the response data. The master device 20 performs the frequency channel hopping to determine a frequency channel to be used, and transmits request data and receives response data on the determined frequency channel (frequency).

Similarly, the slave device 30 also performs the frequency channel hopping for each transmission-reception cycle to determine the frequency channel to be used, and receives the request data and transmits the response data on the determined frequency channel (frequency). The slave device 30 performs the frequency channel hopping according to information shared with the master device 20. Therefore, the master device 20 and the slave device 30 can transmit and receive data using a common frequency channel.

### <Electric Field Strength Distribution>

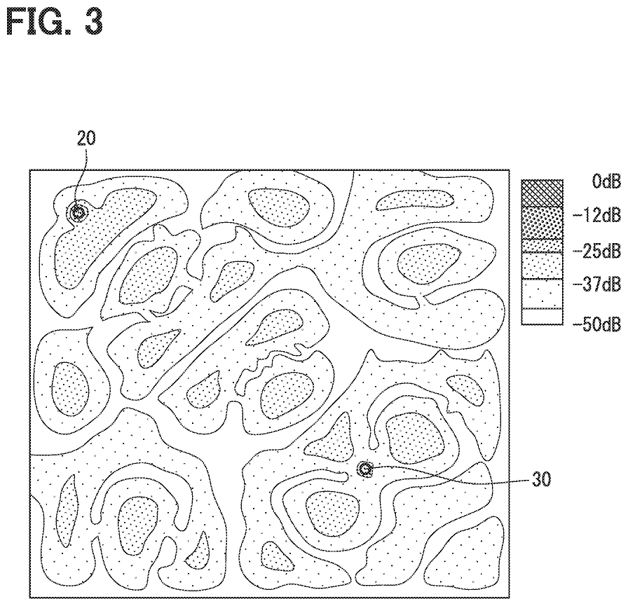

FIG. 3 is a diagram showing the electric field strength distribution of the communication environment between the master device 20 and the slave device 30. FIG. 3 shows an electromagnetic field simulation result at a predetermined timing at a predetermined frequency. In the following, the electric field strength distribution may be referred to as electric field distribution.

The placements of the master device 20 and the slave device 30 are set in the vehicle. When radio waves of a predetermined frequency are emitted from at least one of the master device 20 or the slave device 30, interference with the transmitted wave and the reflected wave or interference with external noise causes areas with high electric field strength and areas with low electric field strength in the usage environment. The reflected waves are caused by reflections from vehicle metal elements existing around the devices 20 and 30, for example, reflections from the vehicle body, metal housings, harnesses, and the like. In the communication environment between the master device 20 and the slave device 30, multiple NULL points, which are portions with a low electric field strength, occur.

An electric field distribution of the communication environment changes depending on at least one of a vehicle state or a state of a surrounding environment of the vehicle. That is, positions of NULL points can change. The electric field distribution changes depending on, for example, a physical quantity indicating the vehicle state or a physical quantity indicating the state of the surrounding environment of the vehicle. One example of the physical quantity is the speed of a vehicle. As the vehicle speed changes, the operating conditions of other systems change, and the effect of external noise on wireless communications changes. Further, the vibration also changes depending on the vehicle speed, and thereby the propagation path of radio waves changes. Further, the temperature of specific equipment of the vehicle, the ambient temperature, and the like change depending on the vehicle speed. Thus, the electric field distribution changes depending on the vehicle speed.

### <Availability Determination Process>

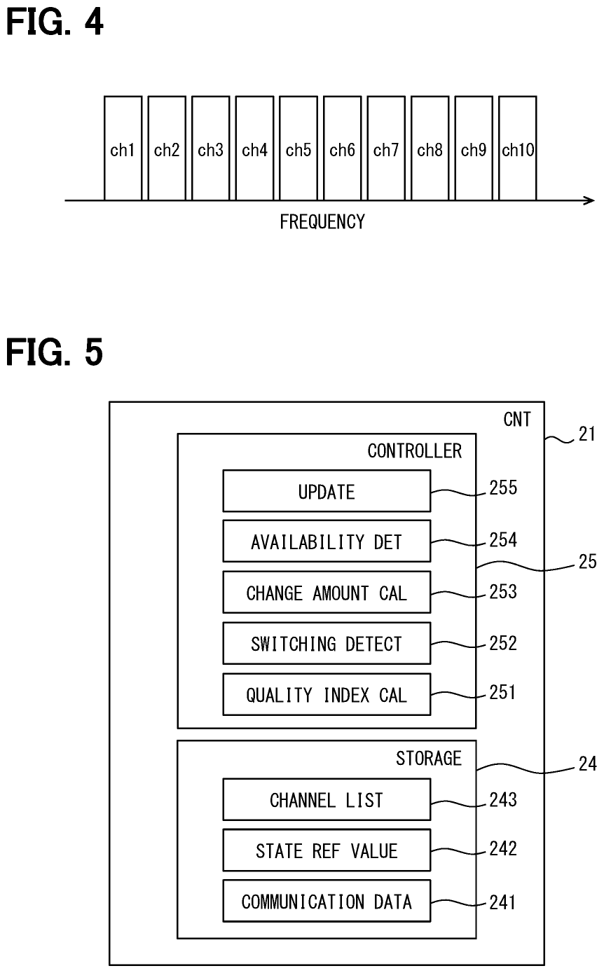

FIG. 4 shows one example of available frequency channels. Hereinafter, the frequency channel may be indicated as ch. The available frequency channel is a frequency channel allocated for data communication among multiple frequency channels. As shown in FIG. 4, frequency channels that can be used for data transmission-reception (data communication) between the master device 20 and the slave device 30 are predetermined.

As one example, in the present embodiment, a total of 10 channels from ch1 to ch10 can be used. The frequency channels have a predetermined frequency width and different frequencies. In the example shown in FIG. 4, ch1 has the lowest frequency and ch10 has the highest frequency. The number of frequency channels available for data transmission and reception may be more or less than ten channels. The master device 20 and the slave device 30 may share information of available frequency channels as initial information, for example, or may have information of available common frequency channels in advance.

FIG. 5 is a block diagram showing a configuration of the control circuit 21 of the master device 20. FIG. 5 shows a part of functional units provided by the control circuit 21. The control circuit 21 includes a storage 24 and a controller 25. The storage 24 is constructed within the memory 212. The storage 24 stores communication data 241, a state reference value 242, and a channel list 243.

The communication data 241 is performance data and a quality index described later. When the state is switched, the communication data 241 is cleared (reset). The state reference value 242 is a reference value indicating switching from a first state to a second state, and is set in advance. The state reference value 242 is a boundary value between the first state and the second state. Only one state reference value 242 may be set, or multiple state reference values 242 may be set. In one example, the state reference value 242 in the present embodiment is a vehicle speed. The vehicle speed, which is the state reference value 242, may be set only once, for example, 50 km/h, or may be set in multiple steps, for example, every 10 km/h. In FIG. 5, the state reference value 242 may be also referred to as “STATE REF VALUE”.

The channel list 243 may be a list indicating the available frequency channels or a list indicating unavailable frequency channels. A list showing available frequency channels and unavailable frequency channels may also be used as the channel list 243.

The controller 25 is a functional unit constructed by the processor 211. The controller 25 includes a quality index calculation unit 251, a switching detection unit 252, a change amount calculation unit 253, an availability determination unit 254, and an update unit 255. In FIG. 5, the quality index calculation unit 251 may be also referred to as “QUALITY INDEX CAL”, the switching detection unit 252 may be also referred to as “SWITCHING DETECT”, the change amount calculation unit 253 may be also referred to as “CHANGE AMOUNT CAL”, the availability determination unit 254 may be also referred to as “AVAILABILITY DET”, and the update unit 255 may be also referred to as “UPDATE”.

The quality index calculation unit 251 calculates a communication quality index (quality index) for each used frequency channel based on the transmission-reception results (performance data) between the master device 20 and the slave device 30. The quality index is stored as the communication data 241. The quality index is, for example, PER. The PER is an abbreviation for Packet Error Rate. In one example, the quality index calculation unit 251 of the present embodiment calculates PER (packet error rate). The PER indicates the ratio of the number of error packets to the number of packets received by the master device 20 as a percentage.

As the quality index, BER or PAR may be used instead of PER. The BER is an abbreviation for Bit Error Rate. The PAR is an abbreviation for Packet Arrival Rate. Two or more among PER, BER, and PAR may be used.

The switching detection unit 252 acquires at least one of the state of the vehicle (mobile body) or the state of the surrounding environment of the vehicle, and detects the state switching. The switching detection unit 252 acquires physical quantities indicating the state of the vehicle or the state of the surrounding environment of the vehicle from in-vehicle devices such as sensors and ECUs. The switching detection unit 252 detects switching from the first state to the second state based on the obtained physical quantity and the state reference value 242.

The change amount calculation unit 253 calculates the amount of change in the quality index during a period between the timing when the state switching is detected by the switching detection unit 252 and a predetermined timing before the detected state switching timing. That is, the amount of change in the quality index immediately before the state switching is calculated. The change amount calculation unit 253 calculates the change amount by, for example, differentiation processing, approximation by the method of least squares, or the like. The change amount calculation unit 253 calculates the change amount for each frequency channel.

The availability determination unit 254 determines availability for each frequency channel based on the calculated change amount. The availability determination unit 254 may compare the amount of change with a preset threshold, for example, to determine the availability. The availability determination unit 254 may determine the availability based on the polarity of the amount of change, that is, increase (plus) or decrease (minus). The availability determination unit 254 updates the channel list 243 based on the determination result. The availability determination unit 254 reflects the determination result in the channel list 243.

The update unit 255 updates the channel list 243 based on the determination result. The update unit 255 reflects the determination result of the availability determination unit 254 in the channel list 243. The update unit 255 may update the frequency channel hopping pattern. The update unit 255 may update the frequency channel hopping pattern based on the channel list 243.

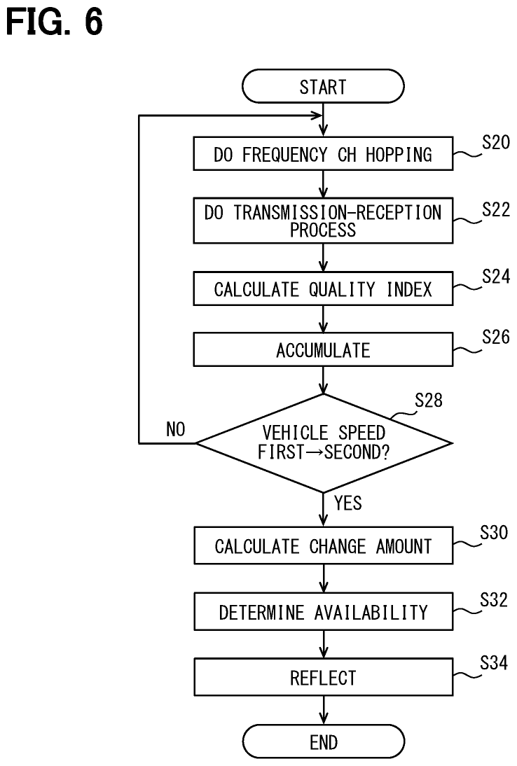

FIG. 6 shows an example of the availability determination process executed by the master device 20. First, the master device 20 performs frequency channel hopping to perform data communication with the slave device 30, and determines the frequency channel to be used in the current transmission-reception cycle (S20). The master device 20 performs the frequency channel hopping every data transmission-reception cycle.

The frequency channel hopping method is not particularly limited. In one example, the master device 20 of the present embodiment determines the frequency channel to be used according to the frequency channel hopping pattern. Hereinafter, the frequency channel hopping pattern may be referred to as a hopping pattern. Alternatively, a predetermined function may be used to determine the frequency channel to be used. The hopping pattern and the function are included in the above initial information, for example.

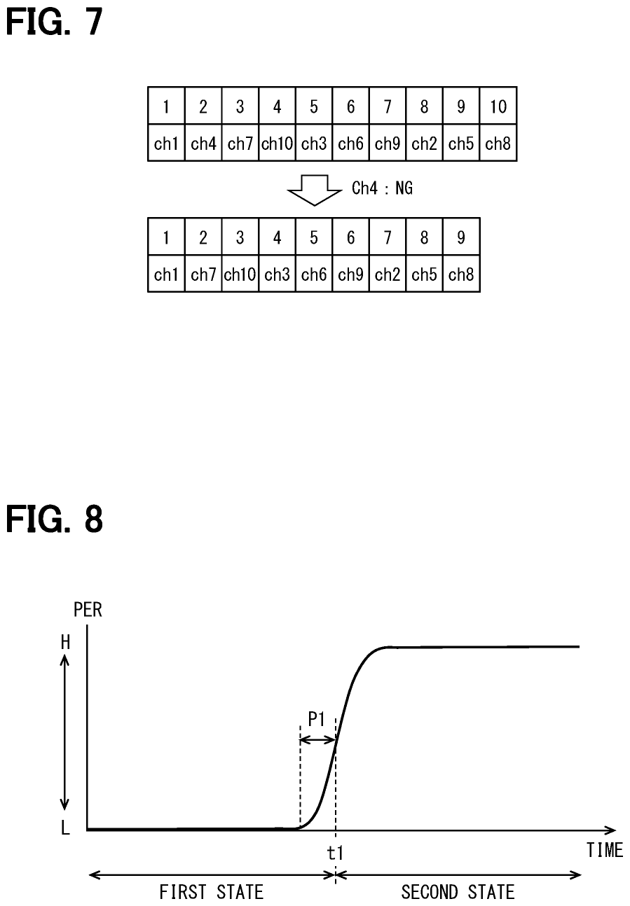

FIG. 7 shows one example of the hopping pattern. The upper part of FIG. 7 is the hopping pattern shared as initial information. That is, it is the hopping pattern before reflecting the availability. In the present embodiment, the frequency channels to be used are switched in this order of ch1, ch4, ch7, ch10, ch3, ch6, ch9, ch2, ch5, ch8, and ch1. In this way, a function can also be used to shift the frequency channel by a predetermined number. For example, the ch1 is used for the first data communication after execution of the startup process.

Next, the master device 20 executes a transmission-reception process on the determined frequency channel (S22). The frequency channel hopping and the transmission-reception process correspond to transmission of request data and reception of response data shown in FIG. 2. The slave device 30 also determines the frequency channel to be used according to the hopping pattern common to the master device 20 before executing the transmission-reception process. The master device 20 and slave device 30 determine a common frequency channel.

Next, the master device 20 then calculates the quality index (S24). The master device 20 calculates the quality index based on the transmission-reception result of S22. The master device 20 may calculate the quality index, for example, based on information about a reception state of the response data (response signal). The master device 20 may acquire information about a reception state of the request data (request signal) from the slave device 30 as part of the communication data and calculate the quality index. The master device 20 calculates the quality index based on at least one of the information regarding the reception state of the request data or the information regarding the reception state of the response data.

In one example, the master device 20 of the present embodiment calculates PER, for example. The master device 20 calculates the quality index individually for each frequency channel.

Next, the master device 20 then accumulates the calculated quality index (S26). The master device 20 stores the quality index together with time information as the communication data 241 in the memory 212 (storage 24).

Next, the master device 20 then determines whether the vehicle speed, which is a physical quantity indicating at least one of the state of the vehicle or the state of the surrounding environment of the vehicle, has changed from the first state to the second state (S28). The master device 20 acquires the vehicle speed from a sensor, an ECU, or the like, and detects switching from the first state to the second state based on the acquired vehicle speed and the state reference value 242. In one example, the physical quantity is the vehicle speed, and the state reference value 242 is 50 km/h. For example, a state less than 50 km/h is the first state, and a state of 50 km/h or more is the second state.

When the vehicle speed is less than the state reference value 242, the master device 20 determines that the state has not been switched to the second state. In this case, the processes after S20 are executed again. When the vehicle speed is equal to or more than the state reference value 242, the master device 20 determines that the state has switched to the second state. Upon determining that the state has switched to the second state, the master device 20 calculates the amount of change in the quality index (S30).

FIG. 8 is a diagram showing a state switching timing and changes in PER, which is a quality index. FIG. 8 shows the PER of one frequency channel. The H and the L in the figure respectively indicate high and low. The PER changes significantly as the state is switched. The PER begins to rise before switching to the second state, and rises across a switching timing t1. The master device 20 calculates the amount of change in the PER in a period P1 between the state switching timing t1 detected in S28 and a predetermined timing before t1. The master device 20 calculates the amount of change by, for example, differentiation processing. The master device 20 calculates the amount of change for each frequency channel.

Next, the master device 20 determines whether each frequency channel is available based on the calculated change amount (S32). The master device 20 compares the change amount with a preset threshold, for example, and determines whether the channel is available. The master device 20 determines that the channel is available when the change amount is less than the threshold, and determines that the channel is not available when the change amount is greater than or equal to the threshold.

Next, the master device 20 reflects the determination result of S32 on the use of the frequency channel (S34), and ends the series of processes. The master device 20 updates the channel list 243 based on the determination result. The master device 20 transmits information related to the updated channel list 243 to the slave device 30. The master device 20 may update the hopping pattern based on the channel list 243, for example. Reflection in the hopping pattern may be performed in S20.

The master device 20 repeats the processes of S20 to S34 after the above-described startup process ends. The master device 20 executes the above-described availability determination process when transmitting data to the slave device 30 or receiving data from the slave device 30.

The lower part of FIG. 7 shows one example of a hopping pattern in consideration of the unavailable frequency channel. For example, when ch4 is determined to be unavailable, the master device 20 excludes ch4 from the hopping pattern. When the frequency channel hopping is performed in the period next to a transmission-reception period using ch1, the frequency channel to be used is switched to ch7. The use of the unavailable frequency channel is avoided by performing the frequency channel hopping again when the unavailable channel is selected without excluding it from the hopping pattern.

### <Overview of First Embodiment>

As described above, each placement of the master device 20 and the slave devices 30 is fixed in the vehicle (moving body). Multiple NULL points occur in the communication environment between the master device 20 and the slave device 30 due to the interference between the transmitted wave and the reflected wave and the interference with external noise. The electric field of the communication environment changes depending on at least one of the vehicle state or the state of the surrounding environment of the vehicle. That is, the position of the NULL point changes.

The PER, which is the quality index, is affected by the electric field distribution in the usage environment. The PER changes greatly at the timing when the electric field distribution changes. In the present embodiment, the master device 20 determines whether each frequency channel is available based on the amount of change in the PER during the period P1 immediately before the switching from the first state to the second state. Then, the determination result is reflected in the use of the frequency channel. In this way, the change in the PER is used as a sign detection of the change in the electric field distribution. Then, the frequency channel in which the change in PER is detected is immediately made unavailable. Therefore, it is possible to prevent continuous occurrence of communication errors, such as when the frequency channel is disabled after the quality index exceeds the threshold.

Thereby, it is possible to provide the wireless communication system 10 capable of highly reliable wireless communication.

The electric field distribution changes depending on, for example, the physical quantity indicating the vehicle state or the physical quantity indicating the state of the surrounding environment of the vehicle. In the present embodiment, the vehicle speed is used as the physical quantity. As the vehicle speed changes, the operating conditions of other systems change, and the effect of external noise on wireless communications changes. Generally, as the vehicle speed increases, the load on at least one of the other systems increases, so that the influence of external noise increases. In addition, vibrations according to the vehicle speed, more specifically, vibrations caused by traveling, vibrations caused by the operation of the equipment, and the like also change. Thereby, the position of a metal body such as a harness is displaced, and the propagation path of radio waves is changed. In general, as the vehicle speed increases, the amount of vibration increases and the propagation path tends to change.

Further, the temperature of specific equipment of the vehicle, the ambient temperature, and the like change depending on the vehicle speed. In general, as the vehicle speed increases, the temperature of a certain equipment increases. Characteristics of the hardware that constitutes the master device 20 and the slave device 30 change depending on the temperature. The temperature affects transmission and reception results. As described above, the electric field distribution changes according to the vehicle speed. The electric field distribution is likely to change as the vehicle speed switches from the first state to the second state. As shown in FIG. 8, it is highly likely that the PER, which is the quality indicator, increases as the state is switched from the first state to the second state.

In the present embodiment, when the vehicle speed switches from the first state to the second state, the amount of change in PER in the period P1 between the switching timing t1 and the predetermined timing before the period P1 is calculated. Then, based on the calculated change amount, it is determined whether each frequency channel is available, and the determination result is reflected in the use of the frequency channel. Accordingly, the highly reliable wireless communication is possible.

With respect to the state reference value 242, the low speed is set to the first state, and the high speed is set to the second state, but the settings may be changed. The high speed may be set to the first state, and the low speed may be set to the second state.

### Second Embodiment

The second embodiment is a modification of a precedent embodiment as a basic configuration and may incorporate description of the precedent embodiment.

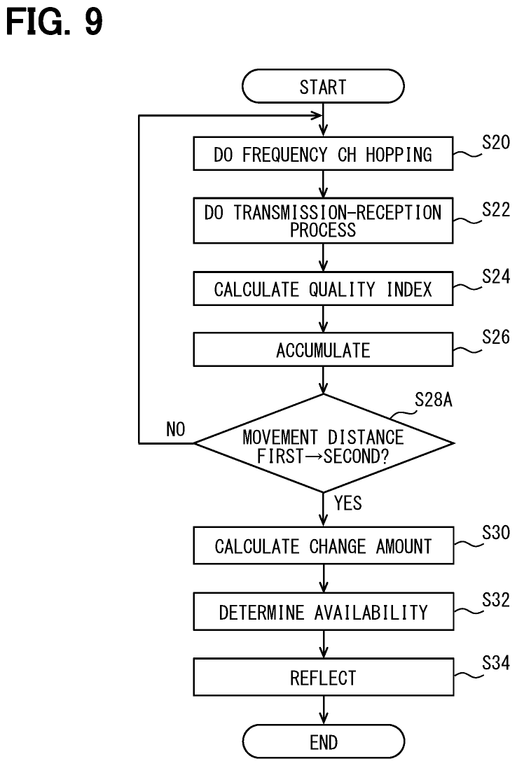

FIG. 9 shows an availability determination processing executed by the master device 20 in the wireless communication system 10 according to the present embodiment. In FIG. 9, instead of S28 of the process shown in FIG. 6, the process of S28A is executed. Other processes are the same as in FIG. 6.

As shown in S28A, in the present embodiment, a movement distance of the vehicle is employed as the physical quantity indicating at least one of the state of the vehicle or the state of the surrounding environment of the vehicle. The movement distance is sometimes referred to as the traveling distance. In S28A, the master device 20 determines whether the travel distance of the vehicle has switched from the first state to the second state. The master device 20 acquires the traveling distance from an odometer or the like, and detects switching from the first state to the second state based on the acquired traveling distance and the state reference value 242. In one example, the state reference value 242 is set within a range of several hundred meters to several kilometers. For example, a state less than 1 km from the traveling start is the first state, and a state of 1 km or more is the second state. The state reference value 242 may be provided in multiple stages. For example, the state reference value 242 may be set every 1 km.

When the movement distance is less than the state reference value 242, the master device 20 determines that the state has not been switched to the second state. In this case, the processes after S20 are executed again. When the movement distance is equal to or greater than the state reference value 242, the master device 20 determines that the state has been switched to the second state, and executes the process of S30, that is, calculates the amount of change in the quality index.

### <Overview of Second Embodiment>

There is a high possibility that the traveling environment of the vehicle has changed depending on the movement distance. The influence of disturbance noise on the communication environment also changes depending on the traveling environment. Therefore, the electric field distribution changes depending on the movement distance. The electric field distribution is likely to change as the movement distance switches from the first state to the second state.

In the present embodiment, when the movement distance switches from the first state to the second state, the amount of change in PER in the period P1 between the switching timing t1 and the predetermined timing before the period P1 is calculated. Then, based on the calculated change amount, it is determined whether each frequency channel is available, and the determination result is reflected in the use of the frequency channel. Accordingly, the highly reliable wireless communication is possible.

### Third Embodiment

The third embodiment is a modification of precedent embodiments as a basic configuration and may incorporate description of the precedent embodiments.

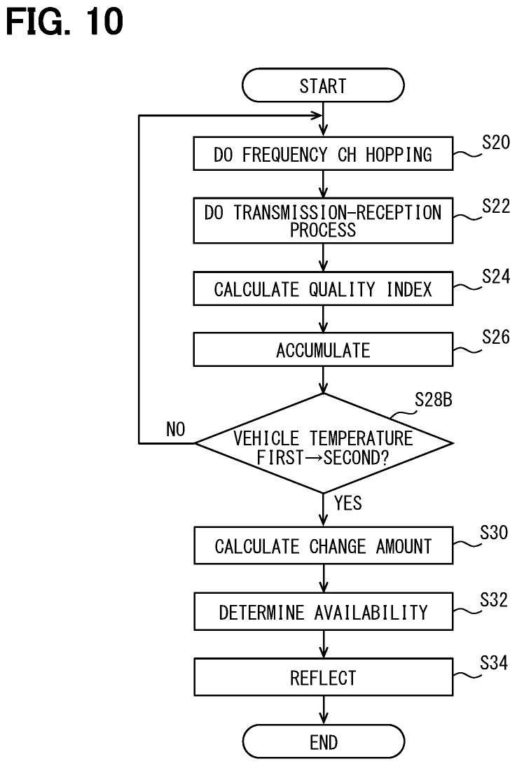

FIG. 10 shows an availability determination process executed by the master device 20 in the wireless communication system 10 according to the present embodiment. In FIG. 10, instead of S28 of the process shown in FIG. 6, the process of S28B is executed. Other processes are the same as in FIG. 6.

As shown in S28B, in the present embodiment, a vehicle temperature is employed as the physical quantity indicating at least one of the state of the vehicle or the state of the surrounding environment of the vehicle. The vehicle temperature may be the temperature of the space where the master device 20 or the slave device 30 is placed. The temperature may be a temperature of the in-vehicle equipment in which at least one of the master device 20 or the slave device 30 is placed. For example, a temperature of a device controlled by the master device 20 may be used.

In S28B, the master device 20 determines whether the vehicle temperature has switched from the first state to the second state. The master device 20 acquires the vehicle temperature from a temperature sensor or the like, and detects switching from the first state to the second state based on the acquired vehicle temperature and the state reference value 242. The state reference value 242 is a predetermined temperature. When the predetermined temperature is 40° C., a state below 40° C. is the first state, and a state of 40° C. or more is the second state. The state reference value 242 may be provided in multiple stages. For example, the state reference value 242 may be set every 10° C.

When the vehicle temperature is less than the state reference value 242, the master device 20 determines that the state has not been switched to the second state. In this case, the processes after S20 are executed again. When the vehicle temperature is equal to or greater than the state reference value 242, the master device 20 determines that the state has been switched to the second state, and executes the process of S30, that is, calculates the amount of change in the quality index.

### <Overview of Third Embodiment>

As described above, the characteristics of the hardware forming the master device 20 and the slave device 30 change depending on the vehicle temperature. Therefore, the electric field distribution changes depending on the vehicle temperature. The electric field distribution is likely to change as the vehicle temperature switches from the first state to the second state.

In the present embodiment, when the vehicle temperature switches from the first state to the second state, the amount of change in PER in the period P1 between the switching timing t1 and the predetermined timing before the period P1 is calculated. Then, based on the calculated change amount, it is determined whether each frequency channel is available, and the determination result is reflected in the use of the frequency channel. Accordingly, the highly reliable wireless communication is possible.

Although the example of the vehicle temperature is shown in the present embodiment, a different temperature may be used. A temperature of an external atmosphere, that is, an ambient temperature may be used.

With respect to the state reference value 242, the low temperature is set to the first state, and the high temperature is set to the second state, but the settings may be changed. The high temperature may be set to the first state, and the low temperature may be set to the second state.

### Fourth Embodiment

The fourth embodiment is a modification of precedent embodiments as a basic configuration and may incorporate description of the precedent embodiments.

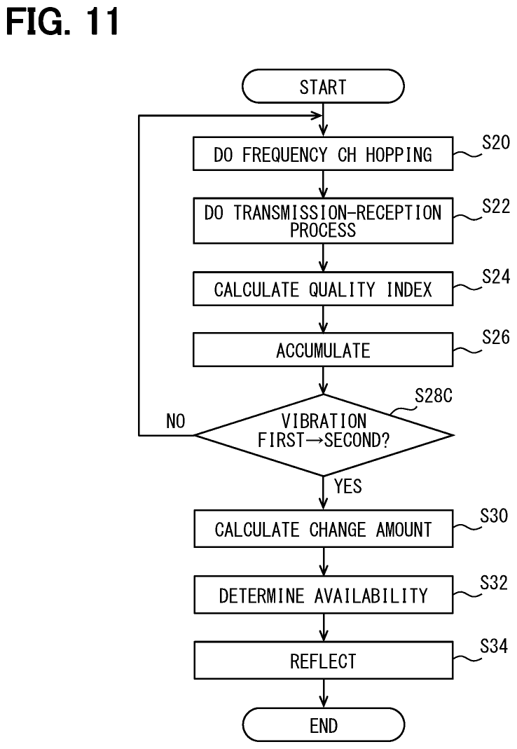

FIG. 11 shows an availability determination process executed by the master device 20 in the wireless communication system 10 according to the present embodiment. In FIG. 11, instead of S28 of the process shown in FIG. 6, the process of S28C is executed. Other processes are the same as in FIG. 6.

As shown in S28C, in the present embodiment, vibration is employed as the physical quantity indicating at least one of the state of the vehicle or the state of the surrounding environment of the vehicle. In S28C, the master device 20 determines whether the vibration amount has switched from the first state to the second state. The master device 20 acquires the vibration amount from a gyro sensor or the like, and detects switching from the first state to the second state based on the acquired vibration amount and the state reference value 242. The state reference value 242 is a predetermined vibration amount. The state reference value 242 may be provided in multiple stages.

When the vibration amount is less than the state reference value 242, the master device 20 determines that the state has not been switched to the second state. In this case, the processes after S20 are executed again. When the vibration amount is equal to or greater than the state reference value 242, the master device 20 determines that the state has been switched to the second state, and executes the process of S30, that is, calculates the amount of change in the quality index.

### <Overview of Fourth Embodiment>

As described above, vibrations, more specifically, vibrations with traveling, vibrations with the operation of equipment, and the like, cause positional displacement of the metal body such as the harness, for example, and change the propagation path of radio waves. In general, the larger the vibration amount, the easier it is for the propagation path to change. The electric field distribution changes in response to vibration. The electric field distribution is likely to change as the vibration switches from the first state to the second state.

In the present embodiment, when the vibration switches from the first state to the second state, the amount of change in PER in the period P1 between the switching timing t1 and the predetermined timing before the period P1 is calculated. Then, based on the calculated change amount, it is determined whether each frequency channel is available, and the determination result is reflected in the use of the frequency channel. Accordingly, the highly reliable wireless communication is possible.

With respect to the state reference value 242, the small vibration amount is set to the first state, and the large vibration amount is set to the second state, but the settings may be changed. The large vibration amount may be set to the first state, and the small vibration amount may be set to the second state.

### Fifth Embodiment

The fifth embodiment is a modification of precedent embodiments as a basic configuration and may incorporate description of the precedent embodiments.

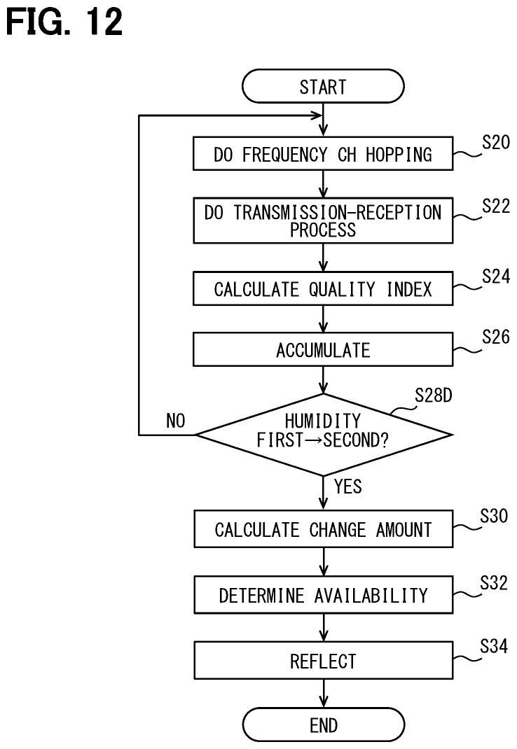

FIG. 12 shows an availability determination process executed by the master device 20 in the wireless communication system 10 according to the present embodiment. In FIG. 12, instead of S28 of the process shown in FIG. 6, the process of S28D is executed. Other processes are the same as in FIG. 6.

As shown in S28D, in the present embodiment, humidity is employed as the physical quantity indicating at least one of the state of the vehicle or the state of the surrounding environment of the vehicle. The humidity is, for example, relative humidity. In S28D, the master device 20 determines whether the humidity has switched from the first state to the second state. The master device 20 acquires the humidity from a humidity sensor or the like, and detects switching from the first state to the second state based on the acquired humidity and the state reference value 242. The state reference value 242 is a predetermined humidity. When the predetermined humidity is 70% RH, less than 70% RH is the first state, and 70% RH or more is the second state. The state reference value 242 may be provided in multiple stages. For example, the state reference value 242 may be provided every 10% RH.

When the humidity is less than the state reference value 242, the master device 20 determines that the state has not been switched to the second state. In this case, the processes after S20 are executed again. When the humidity is equal to or greater than the state reference value 242, the master device 20 determines that the state has been switched to the second state, and executes the process of S30, that is, calculates the amount of change in the quality index.

### <Overview of Fifth Embodiment>

Moisture in the air interferes with radio wave propagation. High humidity, that is, high moisture density in the air, reduces the electric field strength. As described above, the electric field distribution changes depending on the humidity. The electric field distribution is likely to change as the humidity switches from the first state to the second state.

In the present embodiment, when the humidity switches from the first state to the second state, the amount of change in PER in the period P1 between the switching timing t1 and the predetermined timing before the period P1 is calculated. Then, based on the calculated change amount, it is determined whether each frequency channel is available, and the determination result is reflected in the use of the frequency channel. Accordingly, the highly reliable wireless communication is possible.

With respect to the state reference value 242, the low humidity is set to the first state, and the high humidity is set to the second state, but the settings may be changed. The high humidity may be set to the first state, and the low humidity may be set to the second state.

### Sixth Embodiment

The sixth embodiment is a modification of precedent embodiments as a basic configuration and may incorporate description of the precedent embodiments.

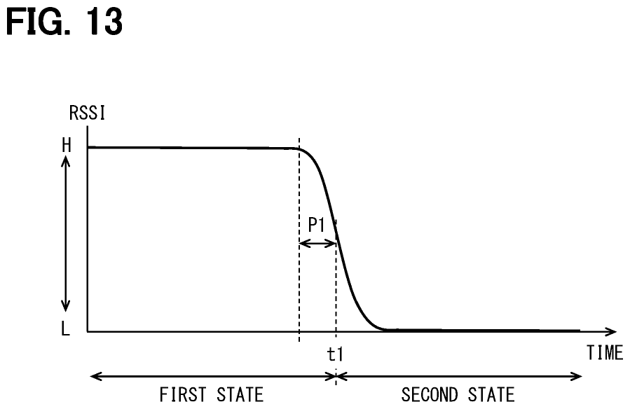

FIG. 13 is a diagram showing the state switching timing and the change in quality index in the wireless communication system 10 according to the present embodiment. In the present embodiment, RSSI (received signal strength) is used as a quality indicator instead of PER. The RSSI is an abbreviation for Received Signal Strength Indicator. FIG. 13 shows the RSSI of one frequency channel. The H and the L in the figure respectively indicate high and low.

The RSSI changes depending on at least one of the state of the vehicle or the state of the surrounding environment of the vehicle. As shown in FIG. 13, the RSSI greatly changes as the state is switched. The RSSI begins to decrease, for example, before the vehicle speed switches to the second state, and continues to decrease across the switching timing t1. The master device 20 calculates the amount of change in the RSSI in the period P1 between the state switching timing t1 detected in S28 and a predetermined timing before the timing t1. The master device 20 calculates the amount of change by, for example, differentiation processing. The master device 20 calculates the amount of change for each frequency channel. Other configurations are the same as those described in the preceding embodiments.

### <Overview of Sixth Embodiment>

The RSSI, which is the quality index, is affected by the electric field distribution in the usage environment. The RSSI changes greatly at the timing when the electric field distribution changes. In the present embodiment, the master device 20 determines whether each frequency channel is available based on the amount of change in the RSSI during the period P1 immediately before the switching from the first state to the second state. Then, the determination result is reflected in the use of the frequency channel. In this way, the change in the RSSI is used as a sign detection of the change in the electric field distribution. Then, the frequency channel in which the change in RSSI is detected is immediately made unavailable. Therefore, it is possible to prevent continuous occurrence of communication errors, such as when the frequency channel is disabled after the quality index exceeds the threshold. Thereby, it is possible to provide the wireless communication system 10 capable of highly reliable wireless communication.

At least one of PER, BER, or PAR may be used as a quality index along with RSSI.

With respect to the state reference value 242, the low speed is set to the first state, and the high speed is set to the second state, but the settings may be changed. The high speed may be set to the first state, and the low speed may be set to the second state.

The physical quantity indicating the state is not limited to vehicle speed. Combinations with any of the physical quantities described in the preceding embodiments are possible.

### Other Embodiments

The disclosure in the present disclosure and drawings is not limited to the exemplified embodiments. The present disclosure encompasses the exemplified embodiments and modifications thereof by those skilled in the art. For example, the present disclosure is not limited to the parts and/or combinations of elements shown in the embodiments. The present disclosure may be implemented in various combinations thereof. The present disclosure may include additional configuration that can be added to the above-described embodiments. The present disclosure also includes modifications which include partial components/elements of the above-described embodiments. The present disclosure includes replacements of components and/or elements between one embodiment and another embodiment, or combinations of components and/or elements between one embodiment and another embodiment The disclosed technical scope is not limited to the description of the embodiment.

It should be understood that a part of disclosed technical scopes are indicated by claims, and the present disclosure further includes modifications within an equivalent scope of the claims.

The disclosure in the specification, the drawings and the like are not limited by the description of the claims. The disclosures in the specification, the drawings, and the like include the technical ideas described in the claims, and further extend to a wider variety of technical ideas than those described in the claims. Thus, various technical ideas can be extracted from the disclosure of the specification, the drawings and the like without being limited to the description of the present disclosure.

When other wireless systems mounted on vehicles (mobile bodies) are operating, interference with radio waves used by the systems may occur. The interference causes the increase in the noise floor, intermodulation distortion, and the like, and changes PER and RSSI information. The electric field distribution in the usage environment of the wireless communication system 10 changes depending on the operating states of other wireless systems. The operating electric field distribution is likely to change as the operating state switches from the first state to the second state.

Therefore, the master device 20 may directly or indirectly acquire the operating state of the other wireless system, detect switching between the non-operating state and the operating state from the acquired operating state, and determine whether the frequency channel is available. The master device 20 calculates the amount of change in the quality index (for example, PER) in the period P1 at the time of switching from the non-operating state (first state) to the operating state (second state), for example. Then, the master device 20 determines whether the frequency channel is available based on the calculated change amount.

Interference with radio waves used outside the mobile body occurs depending on the position of the mobile body, for example, the traveling position of the vehicle. For example, when the vehicle is traveling around a radio tower, affection by external radio waves may occur. The interference causes the increase in the noise floor, intermodulation distortion, and the like, and changes PER and RSSI information. The electric field distribution in the usage environment of the wireless communication system 10 changes depending on the traveling position. The electric field distribution is likely to change as the traveling position switches from the first state to the second state.

Therefore, the master device 20 acquires information on the position of the subject vehicle from a car navigation system, a locator, or the like. The master device 20 may detect switching between a position with no affection by external radio waves and a position with a possibility of the affection by external radio waves from the acquired position information, and may determine whether the frequency channel is available. The master device 20 calculates the amount of change in the quality index (for example, PER) in the period P1 at the time of switching from the position with no affection by the external radio waves (first state) to the position with the possibility of the affection by the external radio waves (second state), for example. Then, the master device 20 determines whether the frequency channel is available based on the calculated change amount.

Interference with the radio waves of devices owned by passengers for the mobile body other than the operator may occur. The interference causes the increase in the noise floor, intermodulation distortion, and the like, and changes PER and RSSI information. The electric field distribution in the usage environment of the wireless communication system 10 changes depending on the state of the passenger. In a case where the passenger is present, a possibility that the electric field strength will be lower becomes high as compared with a case where the passenger is not present. The electric field distribution is likely to change as a boarding state switches from the first state to the second state.

Therefore, the master device 20 may acquire fellow passenger information from a seat switch, a seat sensor, or the like, detect switching between a non-boarding state and the boarding state from the acquired fellow passenger information, and determine whether the frequency channel is available. The master device 20 calculates the amount of change in the quality index (for example, PER) in period P1 at the time of switching from the non-boarding state (first state) to the boarding state (second state), for example. Then, the master device 20 determines whether the frequency channel is available based on the calculated change amount. When the possessed device is a digital key, the information may be acquired from the digital key.

The influence of noise (external noise) from other systems differs depending on whether the IG signal of the vehicle is on or off. Further, the vibration and the vehicle temperature also change. The electric field distribution changes as the IG signal switches from the first state to the second state. Therefore, the master device 20 may acquire information about the IG signal, detect switching between an on-state of the IG and an off-states of the IG from the acquired information, and determine whether the frequency channel is available.

The master device 20 calculates the amount of change in the quality index (for example, PER) in the period P1 at the time of switching from the off-state of the IG (first state) to the on-state of the IG (second state), for example. Then, the master device 20 determines whether the frequency channel is available based on the calculated change amount. An ACC (accessory) signal or an awake signal may be used instead of the IG signal. An awake on-state is a state in which the ECU operating at Vbat is activated and communicating. The awake signal indicates the operating states of other systems that are noise sources.

When an occupant approaches, the vehicle is more likely to move. The influence of noise from other systems (external noise) differs between when the vehicle is in operation and when it is not in operation. Further, the vibration and the vehicle temperature also change. Therefore, the master device 20 acquires information about the digital key, and calculates the amount of change in the quality index (for example, PER) in the period P1 at the time of switching from a state where the occupant is far from the vehicle (first state) to a state where the occupant is close to the vehicle (second state). Then, the master device 20 may determine whether the frequency channel is available based on the calculated change amount.

Here, the process of the flowchart or the flowchart described in this application includes a plurality of sections (or steps), and each section is expressed as, for example, S20. Further, each section may be divided into several subsections, while several sections may be combined into one section. Furthermore, each section thus configured may be referred to as a device, module, or means.

1. A wireless communication system mounted on a mobile body, the system comprising:
a master device; and
a slave device configured to perform a wireless communication with the master device while switching a frequency channel,
wherein
in response to switching of at least one of a state of the mobile body or a surrounding environment state of the mobile body from a first state to a second state, the master device is configured to determine whether the frequency channel is available based on a change amount of an index indicating a communication quality,
the communication quality is a communication quality in a period between a switching timing from the first state to the second state and a predetermined timing before the switching timing, and
the master device is configured to reflect a result of frequency channel availability determination in a use of the frequency channel.

2. The wireless communication system according to claim 1, wherein
an electric field distribution of a communication environment changes depending on at least one of a physical quantity indicating a state of the mobile body or a physical quantity indicating a state of a surrounding environment of the mobile body.

3. The wireless communication system according to claim 2, wherein
the physical quantity indicating the state of the mobile body is a speed of the mobile body.

4. The wireless communication system according to claim 2, wherein
the physical quantity indicating the state of the mobile body is a movement distance of the mobile body.

5. The wireless communication system according to claim 2, wherein
the at least one of the physical quantity indicating the state of the mobile body or the physical quantity indicating the state of the surrounding environment is at least one of a temperature of the mobile body or a temperature of an external atmosphere.

6. The wireless communication system according to claim 2, wherein
the physical quantity indicating the state of the mobile body is vibration of the mobile body.

7. The wireless communication system according to claim 2, wherein
the physical quantity indicating the state of the surrounding environment is humidity.

8. The wireless communication system according to claim 1, wherein
the index is a packet error rate.

9. The wireless communication system according to claim 1, wherein
the index is a reception signal strength.

10. A wireless communication system mounted on a mobile body, the system comprising:
one or more first processors;
one or more second processors;
a second memory coupled to the one or more second processors and storing program instructions that when executed by the one or more second processors cause the one or more second processors to at least: perform a wireless communication with the one or more first processors while switching a frequency channel; and
a first memory coupled to the one or more first processors and storing program instructions that when executed by the one or more first processors cause the one or more first processors to at least:
in response to switching of at least one of a state of the mobile body or a surrounding environment state of the mobile body from a first state to a second state, determine whether the frequency channel is available based on a change amount of an index indicating a communication quality, wherein the communication quality is a communication quality in a period between a switching timing from the first state to the second state and a predetermined timing before the switching timing; and
reflect a result of frequency channel availability determination in a use of the frequency channel.
